(19) United States
(12) Patent Application Publication
(10) Pub. No.: US 2012/0107110 A1
(43) Pub. Date: May 3, 2012

(54) THERMAL PROTECTION COATING FOR A TURBINE-ENGINE PART, AND A METHOD OF MAKING IT

(75) Inventors: Antonio Cremildo Arantes, Sainte Genevieve des Bois (FR); Laurent Paul Dudon, Viry-Chatillon (FR); Claude Marcel Mons, Savigny le Temple (FR)

(73) Assignee: SNECMA, Paris (FR)

(21) Appl. No.: 13/380,952

(22) PCT Filed: Jul. 1, 2010
(86) PCT No.: PCT/FR2010/051382

§ 371 Date: Dec. 27, 2011

(30) Foreign Application Priority Data
Jul. 2, 2009 (FR) 09/03251

(51) Int. Cl. F04D 29/44; B32B 3/02; E04B 1/74; B32B 5/18; C23C 4/04; B32B 15/04; B32B 5/16

(52) U.S. Cl. 415/200; 428/66.2; 428/220; 428/331; 428/613; 427/452; 252/62

(57) ABSTRACT

A thermal protection coating, in particular for a turbine-engine part (12), the coating being deposited by thermal spraying onto the surface of the part (12) and including at least 80% by volume of hollow ceramic microbeads distributed in a metal alloy based on nickel or cobalt, it being possible for the coating to be deposited on a bonding layer (22) of metal alloy and for it to be covered in a layer (26) providing protection against erosion or against friction wear, or in a reflective layer that reflects thermal radiation.

The invention relates to a thermal protection coating, in particular for a part of a turbine engine such as an airplane turbojet or turboprop, and to a method of making the coating.

In a turbine engine such as an airplane engine, certain parts need to be protected or isolated from heat coming either from a stream of hot gas generated in the turbine engine, or from neighboring parts that are themselves raised to high temperature. It is therefore necessary to fit such parts with thermal protection means that are compatible with the requirements specific to airplane engines: durability, ability to withstand the immediate environment, low weight, simplicity, proven effectiveness, etc.

It is also necessary for such thermal protection means not to be parts that have been added on, but on the contrary for them to be integrated in the parts they protect, which parts already have their own functions in the airplane engine. It is therefore not possible to use thermal protection sheet metal, which although effective constitutes an additional part that increases weight and that reduces the available space inside the engine.

Other potential solutions involving insulating coatings of foam present a lifetime that is short and they are not well adapted to high temperatures.

It is also known to form thermal barriers made of zirconium-based ceramic on the parts for protecting, however such barriers are of limited thickness (less than one millimeter), they are fragile, and they are expensive to make.

It is also possible to envisage cooling certain parts by a flow of air taken from the engine, however that solution degrades engine performance.

The invention thus provides a thermal protection coating for turbine-engine parts, in particular in an airplane engine, which coating does not present the above-mentioned drawbacks.

The invention also provides a thermal protection coating that is simple, easy, and inexpensive to make, that can be of relatively great thickness, and that presents density that is relatively low.

To this end, the invention provides a thermal protection coating, in particular for turbine-engine parts or brake disks, the coating being characterized in that it includes at least 80% by volume of hollow ceramic microbeads distributed in a metal alloy based on nickel or cobalt.

The coating presents thermal conductivity that is less than or equal to 1 watt per meter degree centigrade (W/m.° C.) and its thickness may be as much as about 5 millimeters (mm), which thickness is adjustable and serves to control heat transfer.

Its density is less than 2000 kilograms per cubic meter (kg/m³) and it may be used at temperatures lying in the range −50° C. to +1100° C., depending on the metal alloy that is associated with the ceramic microbeads.

Furthermore, its cost is relatively low, insofar as it is possible to use ceramic microbeads that are derived from the combustion products of incinerators and that are of very low cost.

The ability of the coating of the invention to withstand heat transfer is associated mainly with the presence of the hollow ceramic microbeads, and the proportion thereof by volume may be greater than 90%.

The diameter of the microbeads typically lies in the range 30 micrometers (μm) to 250 μm.

The metal alloy of the coating of the invention may include aluminum, chromium, and yttrium.

It is available in powder form and is therefore suitable for use in thermal spraying.

The invention also provides a method of making a thermal protection coating of the above-described type, the method being characterized in that it consists in forming the coating by thermally spraying a mixture of hollow ceramic microbeads and a powder of a metal alloy based on nickel and on cobalt onto the surface of a part by means of a plasma torch generating a plasma cone directed towards the part, and into which the metal alloy powder and the ceramic microbeads are injected simultaneously and laterally, the powder upstream from the microbeads.

Where necessary, it is possible to begin by forming a metal alloy bonding layer on the surface of the part by thermal spraying, which bonding layer has thickness that lies typically in the range 50 μm to 200 μm, the alloy of the bonding layer preferably being identical to that of the thermal protection coating.

The bonding layer increases the surface roughness of the part and provides better adhesion in traction for the thermal protection coating.

Thereafter, the method may consist in forming on the thermal protection coating a layer for providing protection against erosion or against friction wear, and/or a reflective layer for providing protection against thermal radiation.

The invention also provides a turbine-engine part such as a rear nacelle or a casing, or a brake disk in a braking system, characterized in that it includes a thermal protection coating as described above or made by executing the above-described method.

The invention can be better understood and other characteristics, details, and advantages thereof appear more clearly on reading the following description made by way of example and with reference to the accompanying drawing, in which:

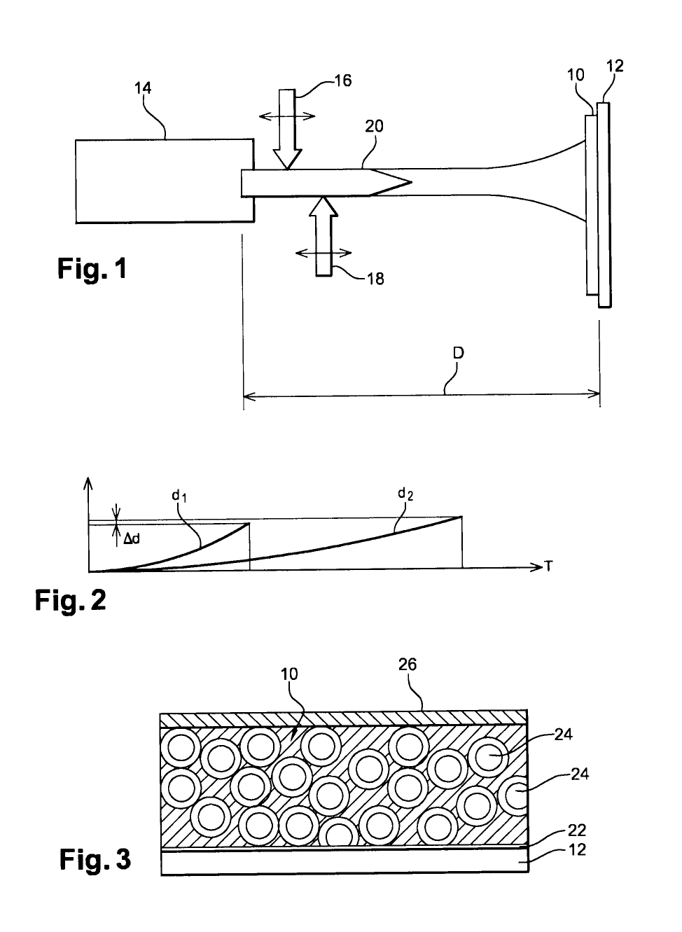

FIG. 1 is a diagram of means for making a thermal protection coating of the invention;

FIG. 2 is a graph plotting thermal expansion curves for a coating of the invention and for the part on which the coating is deposited; and

FIG. 3 is a diagrammatic section view on a large scale of a surface of a part including a thermal protection coating of the invention.

FIG. 1 is a diagram showing means for forming a thermal protection coating 10 on the surface of a part 12, in particular a turbine-engine part, these means comprising a plasma torch 14 having means for delivering plasma-generating gas such as argon and hydrogen, and means for delivering electricity, together with means 16 for laterally injecting a flow of metal powder, and means 18 for laterally injecting a flow of hollow ceramic microbeads, the metal powder and the ceramic microbeads being injected into a plasma cone 20 at a distance D from the surface of the part for coating that is of the order of 150 mm for a torch 14 of a given type.

The positions for injecting metal powder and ceramic beads are adjustable, with ceramic bead injection taking place downstream from metal powder injection in order to take account of the difference between the densities of these two ingredients.

The metal powder injected at 16 into the plasma cone is a powder of a metal alloy such as NiAl, NiCrAl, or MCrAlY, where M is nickel or cobalt or nickel-cobalt, as a function of the temperatures to which the part 12 for protecting is exposed.

By way of example, it is possible to use NiCrAl type alloys for temperatures in ranges between −50° C. and +900° C., and alloys of the MCrAlY type for temperatures ranging up to +1100° C., where M is a metal such as Ni, or Co, or nickel-cobalt.

The hollow ceramic microbeads injected at 18 are of any composition, with a mean diameter lying in the range about 30 μm to about 250 μm, these microbeads being of the alumino-silicate type and being the result of recycling, such as beads derived from combustion in an incinerator.

The mixture sprayed onto the surface of the part 12 includes at least 80% by volume of ceramic microbeads, and preferably at least 90% by volume of such microbeads.

In one implementation, a torch 14 is used to spray onto the surface of the part 12 a mixture of an NiCrAl alloy and hollow ceramic microbeads, with the metal alloy being delivered at a rate of 24 grams per minute (g/min) and the ceramic microbeads being delivered at a rate of 48 g/min. The plasma torch is powered with plasma-generating Ar—H₂ gas at a rate lying in the range 5 liters per minute (L/min) to 50 L/min, and using an electrical current of 500 amps (A). A coating 10 is thus formed on the part 12 presenting a density of 1700 kg/m³ and containing about 95% by volume of hollow ceramic microbeads.

The thermal conductivity of the coating is of the order of 0.7 W/m.° C. to 1.4 W/m.° C. in the range 20° C. to 800° C. The thickness of the coating 10 typically lies in the range about 2 mm to about 5 mm, depending on the temperatures to which the part 12 is subjected.

It is advantageous for the protective coating 10 to have a coefficient of thermal expansion that is less than that of the part 12, as can be seen from the thermal expansion curves of FIG. 2.

This figure plots the curve d₁ for thermal expansion of the part 12 as a function of temperature T, and the curve d₂ for thermal expansion of the coating 10.

During formation of the coating 10, the material of the coating is subjected to a temperature that is considerably higher than the temperature to which the part 12 is exposed. Nevertheless, since the thermal protection coating has a coefficient of expansion that is less than that of the part 12, the thermal expansion of the part 12 and of the coating 10 at the temperatures that are applied to them are substantially equal and the difference Ad is relatively small. Thus, on cooling, the thermal protection coating 10 does not constitute a place in which traction stresses accumulate, where that would be likely to give rise to microcracking in the insulating coating and/or at the interface between the part 12 and the coating 10, where such microcracks provide thermal bridges and degrade thermal insulation.

This makes it possible to form coatings 10 of greater thickness on the part 12 without running the risk of the coating coming off.

Typically, the thermal protection coating 10 presents adhesion on the part 12 lying in the range 5 megapascals (MPa) to 20 MPa, as a function of its content of hollow microbeads, and hardness lying in the range 10 to 80 on the Rockwell HR15Y scale.

When it is desired to improve the adhesion of the coating 10 on the part 12, and as shown in FIG. 3, it is possible to form a bonding layer on the part 12 so as to increase the surface roughness of the part 12 and thereby improve the adhesion of the thermal protection coating.

The bonding layer 22 may be formed by thermally spraying a metallic material that is preferably identical to the metal alloy of the coating 10. The bonding layer 22 may present thickness typically lying in the range 50 μm to 200 μm.

Since the thermal protection coating 10 is sensitive to erosion, because of the presence of hollow ceramic microbeads 24, it is possible to provide an erosion protection layer on the coating 10, this layer 26 being made by thermally spraying a metallic material having thickness that typically lies in the range 50 μm to 150 μm, or indeed depositing a layer of some other material having anti-erosion properties on the coating 10, by painting or by electrolytic deposition (where the coating is electrically conductive).

In a variant, the upper layer 26 may be an antifriction layer or a layer providing protection against friction wear, for example a carbide layer such as WC/Co or WC/CoCr, or indeed a layer of standard metallic material such as NiAl or NiCrAl coated in a film of mineral varnish that withstands high temperatures.

When the part 12 is in an environment where thermal radiation is high, the top layer 26 may have reflective properties relative to the spectrum of the incident radiation. For example, it is possible to deposit on the thermal protection coating 10 a thin layer (e.g. 50 μm to 200 μm thick) of a coating of ceramic such as ZrO₂/Y₂O₃, suitable for use up to temperatures of about 1250° C. Such a layer serves to reflect more than 40% of the received radiant energy.

1. A thermal protection coating comprising (i) at least 80% by volume of hollow ceramic microbeads, based on the total volume of the coating, and (ii) a nickel or cobalt metal alloy, wherein the microbeads are distributed in the metal alloy.

2. The coating of claim 1, comprising at least 90% by volume of hollow ceramic microbeads, based on the total volume of the coating.

3. The coating of claim 1, wherein the coating has a thickness of less than or equal to 5 mm.

4. The coating of claim 1, wherein the microbeads have a diameter of 30 μm to 250 μm.

5. The coating of claim 1, wherein the metal alloy comprises aluminum.

6. The coating of claim 1, wherein the metal alloy comprises chromium.

7. The coating of claim 1, wherein the metal alloy comprises yttrium.

8. A method of producing the coating of claim 1, the method comprising:
thermally spraying with a plasma torch a mixture of hollow ceramic microbeads and a powder of a nickel or cobalt metal alloy onto a surface of a part, wherein the powder and the ceramic microbeads are injected into a plasma cone of the plasma torch simultaneously and laterally, the powder upstream from the microbeads.

9. The method of claim 8, wherein the thermally spraying further comprises forming an alloy bonding layer on the surface of the part, wherein the layer has a thickness of 50 μm to 200 μm, and the layer comprises the same nickel or cobalt metal alloy as the thermal protection coating.

10. The method of claim 8, further comprising forming on the coating a protective layer, a reflective layer, or both.

11. A turbine-engine part comprising the thermal protection coating of claim 1.

12. A disk brake, comprising the thermal protection coating of claim 1.

13. A turbine-engine rear nacelle comprising the thermal protection coating of claim 1.

14. A turbine-engine casing comprising the thermal protection coating of claim 1.

15. The coating of claim 1, wherein the metal alloy comprises nickel and aluminum.

16. The coating of claim 1, wherein the metal alloy comprises nickel, chromium and aluminum.

17. The coating of claim 1, wherein the metal alloy comprises nickel, chromium, aluminum and yttrium.

18. The coating of claim 1, wherein the metal alloy comprises cobalt, chromium, aluminum and yttrium.

19. The coating of claim 1, wherein the metal alloy comprises nickel, cobalt, chromium, aluminum and yttrium.

20. The method of claim 8, further comprising forming on the coating a protective layer comprising (i) tungsten carbide; (ii) nickel and aluminum; or (iii) nickel, chromium and aluminum.
